(19) United States
(12) Patent Application Publication
(10) Pub. No.: US 2010/0268528 A1
(43) Pub. Date: Oct. 21, 2010

(54) Method & Apparatus for Identifying Contract Characteristics

(76) Inventors: Olga Raskina, Arlington, MA (US); Robert Marc Jamison, San Jose, CA (US); Ammiel Kamon, Burlingame, CA (US)

Correspondence Address: ROBERT SCHULER, 45 GROTON ROAD, SHIRLEY, MA, 01464, US

(21) Appl. No.: 12/424,659

(22) Filed: Apr. 16, 2009

(51) Int. Cl. G06F 17/27; G06F 17/21

(52) U.S. Cl. 704/9; 715/256

(57) ABSTRACT

A contract characteristic identification application includes a user interface, a plurality of contract characteristic definitions, a natural language processing module and a characteristic identification function. At least one contract characteristic is defined and evaluated and the text of at least one contract is entering into the application. A document evaluation function included in the natural language processing module operates to evaluate the contents of the text of the contract against the defined contract characteristic and returns a listing of contract text that is closest to the defined contract characteristic of interest.

### TECHNICAL FIELD

This invention is related to the technical areas of information retrieval, document retrieval and text retrieval in documents and it is also related to the area of identifying conceptual ideas contained in documents.

### BACKGROUND

Typically, legal contracts are reviewed for various reasons before they can be agreed to. Contracts created by one party can be reviewed by another party to determine whether or not they contain undesirable contract language, necessary contract language or some other language of particular interest from the perspective of the party reviewing the contract. Generally, the contract review process is performed manually by one or more individuals. Such a manual contract review process can, depending upon the length of the contract, be time consuming and it can be a subjective exercise depending upon the individual or individuals who are responsible for the review process. This review subjectivity can result in several different or inconsistent review reports.

A number of different tools exist which can be employed to search through a collection of documents or textural information, such as a collection of contracts or a single contract, to identify subject matter of interest. One such tool is a search engine. There are a number of commercially available search engines which operate to search for information available on the Internet. Generally, one or more words are entering into the tool as a query and the search engine employs a web crawler to examine information available with respect to web pages that correspond to the words included in the query. The web crawler typically returns the results of this searching process as a listing of web pages or sites that best match the query. Another tool that can be used to identify particular words in document is a text retrieval tool. Such a tool can perform a full text search of each word in each document to identify words that match supplies query words. These search tools relate to the general area of information retrieval which is the science of searching for documents or information contained in the documents based upon some input to the tool which is typically a query. These tools can be useful for identifying a particular word or words (literal meaning) that are included in a legal contract, such as “termination” or “indemnification”, and so do have some utility. But, in the event that the information sought to be identified is not necessary so literal, but rather conceptual in nature, then such tools fall short of being useful.

Natural language processing (NLP) is a field in the area of computer science concerned with converting human language into information useful by a computer program. A number of NLP techniques have been developed which can be employed to process the text of a document so that it is suitable for processing by a computer program. Some of these techniques include text segmentation, part-of-speech tagging, word stemming and synonym tagging to name a few. Another NLP technique referred to as latent semantic analysis or indexing (LSI) was invented to identify concepts or topics that are included in a document or collection of documents. Latent semantic indexing is described in U.S. Pat. No. 4,839,853 as a statistical technique for extracting relations of expected contextual usage of words (concepts) in a document or collection of documents. Latent semantic indexing can be combined with other NLP techniques, such a text segmentation, part-of-speech tagging, word stemming and synonym tagging, to create a concept identification system useful for evaluating a document, such as a legal contract, to identify different types of clauses or topics. When properly trained, such a concept identification system is more useful than simple word searching tools in analyzing legal contracts in the event that the information sought is something other than the literal meaning of a contract passage or some words that are included in a contact passage.

When a query that is composed of one or more key words, such as “cancellation & convenience”, is entered into the concept identification system described above, the system can identify specific clauses included in one or more contracts that are close in meaning or which contain language that provides legal definition to the concept termed “cancellation for convenience”. However, such a concept identification system is not able to identify an abstract contract characteristic, such as a set of one or more contract clauses that exposes a party to the contract to risk or a set of contract clauses that a party to the contract deems should always be included in a contract. Such abstract contract characteristics can include a number of different types of contract clauses, depending upon the perspective of the party reviewing the contract.

### SUMMARY

The limitations of prior art concept identification systems are overcome by a method for identifying document characteristics that is comprised of entering and storing the text of a document into the memory of a computer; defining one or more document characteristics and storing the document characteristics in the computer memory; a trained natural language processing module operating on the one or more document characteristics to generate at least one value for each of the one or more document characteristics and operating on the text of the document to generate a plurality of document concept values; and a document characteristic identification function employing the stored document characteristic values and the stored document concept values to identifying all of the document text that is within a preselected distance of the one or more defined document characteristics.

### BRIEF DESCRIPTION OF DRAWINGS

FIG. 1 is a diagram of a contract characteristic identification system.

FIG. 2 is a functional block diagram of a contract characteristic identification application included in the identification system of FIG. 1.

FIG. 3 is a functional block diagram of a document evaluation function.

FIG. 4 is a diagram showing values resulting from the evaluation of several contract characteristic identification sets by a document evaluation function.

FIG. 5 is a diagram showing values in a two-dimensional matrix structure that result from the evaluation of a contract by the document evaluation function.

FIG. 6 is an illustration of a user interface associated with the contract characteristic identification application of FIG. 2.

FIG. 7 is a logical flow diagram of the method of the preferred embodiment.

### DETAILED DESCRIPTION

The entire contents of the document entitled “Secondary Concept Identification System”, identified by U.S. application Ser. No. 12/275,949, which is attached hereto as Appendix 1 is incorporated into this application by reference. To the extent that a document, such as a legal contract, includes a large number of complex and different types of clauses, each clause or group of clauses being directed to a separate form of protection, the process of manually reviewing the contract for particular clauses, contract text or language of interest can be time consuming and prone to error (the error being associated with simply overlooking or missing clauses or language of interest). The ability to automatically review one or more legal contract, to quickly and accurately identify all or substantially all of the one or more passages or clauses of interest, is a very useful legal tool. Typically, an individual tasked with the responsibility of reviewing a legal contract is doing so with the intent of identifying one or more clauses, language or passages of interest to the party they are reviewing the contract for. These clauses, language or passages are all referred to herein as “contract text” which contract text can be comprised of one or more words and/or sentences. The contract text of interest to a reviewer can be categorized according to the degree of risk associated with the contract text, such as contract text that includes high or unacceptable risk, contract text that includes medium or acceptable risk, contract text that is low in risk or is required to be included in a contract. Contract text that includes high risk can be included in contract clauses directed to the termination of a contract, directed to certain limitations of liability, directed to certain disclaimers or directed to indemnification clauses. Contract text that includes medium risk can include clauses directed to termination of a contract, for instance. Contract text that is low in risk can be a clause which defines the term of a contract, which defines cost or delivery dates, and which defines the parties to a contract. Each of one of these multiple levels of risk can be defined by the party reviewing the contract to be a separate characteristic of the contract. It is very useful to be able to quickly identify these contract characteristics during the time that the contract is being negotiated or created. Further, language one party to a contract considers to be risky may not be considered to be risky language to another party to the contract. Or, one individual reviewing a contract for one party may consider particular language in the contract to be risky while another individual reviewing the same contract for the same party may not consider the same contract language to be risky. Risk, as it relates to language in a contract, is a very subjective and at times abstract concept to those who are reviewing the contract. Therefore, the ability to automatically, quickly, consistently and accurately evaluate a contract can be a very valuable tool. Although, the preferred embodiment of the invention is specifically directed to contracts or legal contracts, the invention can be generally applied to any structured document. For the purpose of this description, the terms “document” and “contract” or “legal contract” are used interchangeably and a contract or legal contract is considered to be a sub-set of all documents.

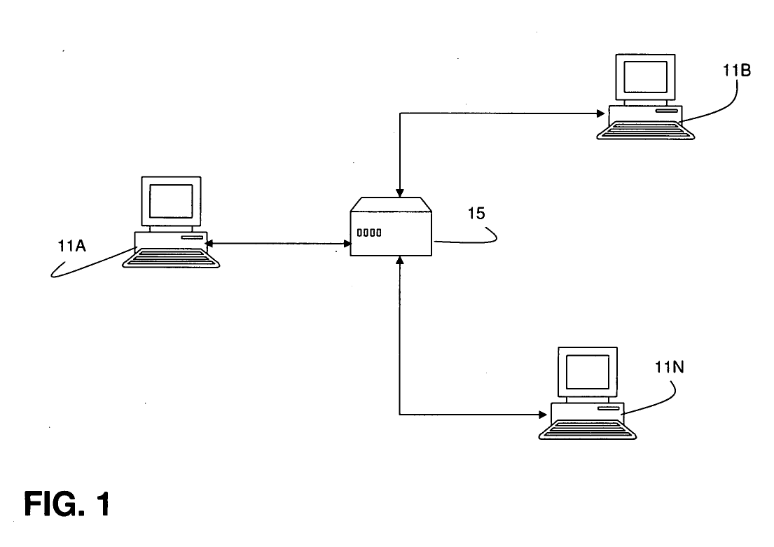

FIG. 1 shows a number of devices in a LAN configuration that can be used to implement a contract characteristic identification system 10 according to one embodiment of the invention. The identification system 10 is comprised of one or more computers 11A to 11N (with N being an integer) each of which can include a contract characteristic identification application that is used to identify characteristics of interest in a contract. A server 15 can also be employed to store the contract characteristic identification application where it is available to any of the computers over the LAN. A scanner 12, or some other suitable device, can be used to enter textual information included in a contract into memory of any one of the computers 11A to 11N or the server 15. Alternately, the text of a contract can be manually entered into one or the computers, the method used to enter the text of the contract into a computer or the server is not important for the operation of the preferred embodiment of the invention. The parties reviewing a contract can pre-define one or more sets of contract characteristics that they are interested to identify in one particular contract or in some or all contracts and these pre-defined contract characteristics are entered into the contract characteristic identification system 10 where they are available to be selected later. Alternatively, these contract characteristics can be defined or created at the time that the contract is being reviewed and stored in the contract characteristic identification system. The automatic contract characteristic identification process can be initiated after one or more contracts are entered into one of the computers, computer 11A for instance, a stored contract characteristic is selected or a contract characteristic is entered into the computer 11A and the contract characteristic identification application stored either in the server 15 or in one of the computers 11A to 11N is invoked.

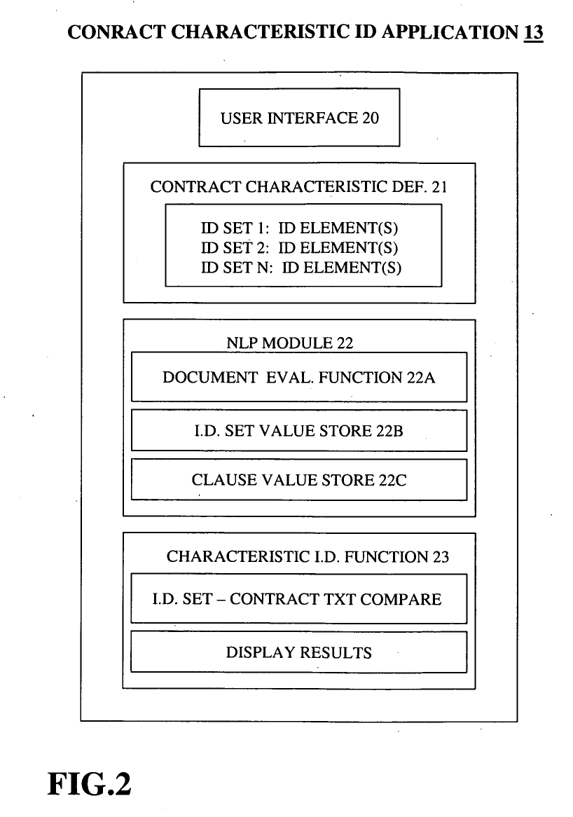

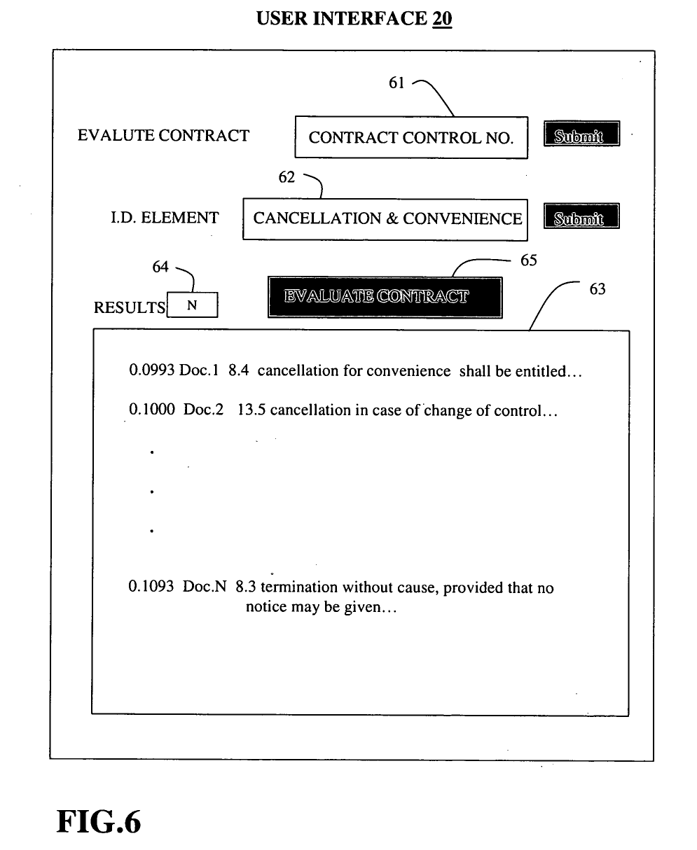

FIG. 2 is a diagram showing functional blocks that can be included in the contract characteristic identification application of FIG. 1, hereinafter referred to as characteristic ID application 13. The characteristic ID application 13 is comprised of four functional modules that operate together to automatically identify certain characteristics of interested in a legal contract or in any text based document. The four modules that comprise the characteristic ID application 13 are a user interface 20, a contract characteristic definition module 21, a natural language processing (NLP) module 22 and a contract characteristic identification function 23. The user interface (UI) 20 includes the functional means by which an individual who is tasked with the responsibility of reviewing a contract interacts with the contract characteristic application 13. The UI 20 provides means for entering information into the ID application 13 and means for displaying the results of the ID application's 13 evaluation of a contract. The UI 20 will be described in greater detail later with reference to FIG. 6. The contract characteristic definition module 21 is accessible via the UI 20 and includes a template that can be used to define contract characteristics that are of interest to the party reviewing a contract. As described previously, the contract characteristics can be abstract contract concepts such as high risk contract text, medium risk contract text and low risk contract text, to name only three. Each contract characteristic is defined by a separate set of characteristic identification elements. In this case, the contract characteristic “low risk” is defined by the “set 1” of identification elements, the contract characteristic “high risk” is defined by the “set 2” of identification elements and the contract characteristic “N” (where N is an integer) is defined by the “set N” of identification elements. Each set of characteristic ID elements is comprised of one or more ID elements. ID set 1 can be comprised of three ID elements, for instance, with a first ID element being “infringement & indemnification”, a second ID element being “mutual & cancellation” and a third ID element being “price & escalator”.

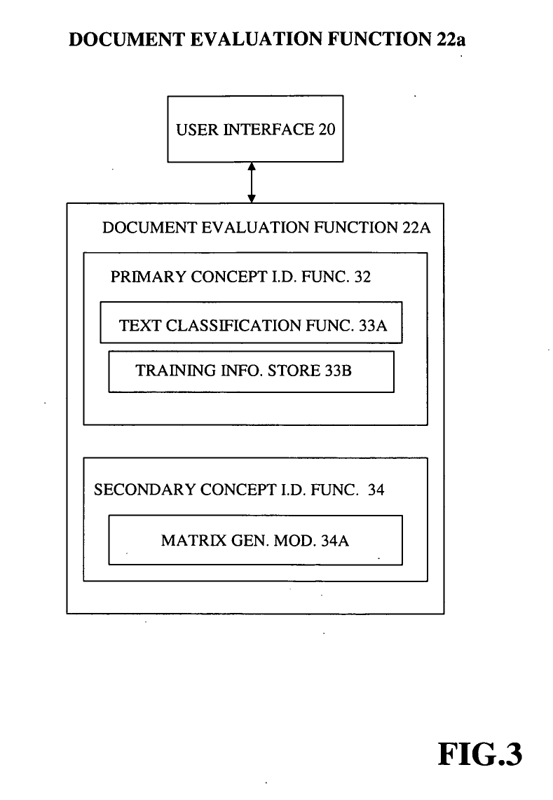

Continuing to refer to FIG. 2, the NLP module 22 is comprised of a document evaluation function 22A, a store 22B of characteristic ID set values (characteristic values) and a store 22C of contract concept values. The document evaluation function 22A generally includes natural language processing functionality that operates on the text of a contract and the defined contract characteristics to identify one or more concepts. Further, the document evaluation function 22 can assign values to the concepts identified in both the defined contract characteristics and the contract and stores these values in the I.D. set value store 22B and the clause value store 22C respectively. And finally, a characteristic identification function 23 operates on one or more selected contract characteristics and one or more selected contracts to identify the contract clauses or contract text that correspond to the selected contract characteristic. The document evaluation function 22A will be described in more detail with reference to FIG. 3 below.

Referring now to FIG. 3, the document evaluation function 22A generally operates on the text of a contract to identify a number of concepts that are included in the contract. A detailed description of the design and operation of the document evaluation function 22A is included in the document attached hereto as Appendix 1. In this document the document evaluation function 22A is referred to as the “Secondary Concept Identification System 10”. The concepts identified can be primary concept and/or the concepts can be secondary concepts. A primary concept is any one of the different types of high-level clauses or contract text that are typically included in a legal contract, such as termination clauses, liability clauses, licensing clauses, performance clauses, indemnification clauses and confidentiality clauses. A secondary concept refers to a lower-level concept that is contained or encompassed by the high-level primary concept. For instance, a primary concept such as a “termination clause” can include such secondary concepts as “termination for convenience” and “termination for nonperformance”. The document evaluation module 22A resides in memory or other storage device that can be included in any one of the computers 11A to 11N or in the server 15 of FIG. 1. For the purpose of this description, it is assumed that the document evaluation function 22A is located in the computer 11A of FIG. 1. Further, in order for the document evaluation function 22A to operate to most accurately identify contract characteristics, it is typically trained on a corpus of documents as described in detail in Appendix 1.

Continuing to refer to FIG. 3, the document evaluation function 22A generally operates to map the concepts identified in a contract into a secondary information store 24B which is described with reference to FIG. 2 in Appendix 1. The document evaluation module 22A includes a primary concept identification function 32 and a secondary concept identification function 34. The primary concept identification function 32 is comprised of a text classification function 33A and a training information store 33B. The Text classification function 33A can include, for instance, one or more of a stemming function, a part of speech tagging function, a synonym tagging function, a significant term identification function or any other natural language processing text classification function. The training information store 33B is the same as the training information store 25 described with reference to FIG. 2 in Appendix 1 and generally maintains textual information about a group of contracts that has been manually entered into the system 10. In general, the primary concept evaluation function 32 operates on contract textual information that is entered into the computer 11A, for instance, to generate a primary concept space that is associated with the contract. The information contained in this primary concept space is stored for use later by the secondary concept identification function 34. During a secondary concept training process, the secondary concept identification function 34 can operate on the stored primary concept space information to decompose the information to identify secondary concepts included in each of the one or more primary concepts included in the contract. The secondary concept identification function 34 can be implemented with, but not limited to, latent semantic analysis or indexing (LSI) or latent Dirichlet allocation (LDA) methodology, which is a technique typically used for analyzing relationships between one or more documents or contracts and the terms or words each of the documents or contracts contain to generate a set of secondary concepts. From another perspective, if all of the primary concepts of one type, which can be all of the termination clauses included in a contract, are processed using the LSI methodology, then the result can be the identification of substantially all of the secondary concepts, associated with the primary concept, that are included in the contract. In this case, two secondary concepts included in the group of termination clauses can be contract text for “termination for cause” and contract text for “termination without cause”. Once substantially all of the secondary concepts associated with each primary concept in the contract are identified, information about the secondary concept space is stored in the clause value store 22C located in the contract characteristic ID application 13 of FIG. 2. In operation, the application 13 receives one or more selected contract characteristic sets 1 to N, described with reference to FIG. 2, one or more selected contracts that have been entered into the system 10 and once invoked, the characteristic ID application 13 automatically identifies all or substantially all of the contract text in the contract that correspond or are close in concept space to the one or more contract characteristics defined in the one or more selected characteristic sets 1 to N. The identified contract text can be displayed as a listing of identified contract text which, in this case, can be a listing of substantially all of the “termination for cause” clauses included in a contract or contracts. The clauses can be listed in order from best scoring match (closest) to worst scoring match (farthest) or any other listing order, such as by date or by company alphabetically, or in any other order.

Table 1 below, is an illustration of several contract characteristic ID sets 1, 2 to N, each ID set of which can include one or more ID elements such as queries, rules or textual information.

TABLE 1
CHARACTERISTIC I.D. SET

| I.D. SET | I.D. ELEMENT |
|---|---|
| I.D. SET 1 | CANCEL FOR CONVENIENCE |
| | CANCEL FOR DEFAULT |
| | CANCEL DUE TO INSOLVENCY |
| I.D. SET 2 | RULE: Contract must include term passage |
| I.D. SET N | TEXT: Contract must include “PARTIES” |

The ID set 1 of Table 1 includes three ID elements. A first ID element is “cancel for convenience”, a second ID element is “cancel for default” and a third ID element is “cancel due to insolvency”. Each of these three “ID set 1” elements can represent a separate query that is created in advance or that is created at the time a contract is reviewed and which together represent a particular contract characteristic of interest to the party reviewing the contract, such as unacceptably risky contract text. After being created, the ID elements can be stored by the characteristic ID application 13 in one of the computers, computer 11A for instance, for later or immediate use by the NLP module 22 of FIG. 2. A contract characteristic ID set can include one or more ID elements that are based on a manually created query as illustrated in Table 1 with respect to ID set 1, an ID set can include one or more ID elements that are based on manually created “rules” as illustrated in Table 1 with respect to ID set 2, or an ID set can include one or more ID elements that are based on one or more text words of interest as illustrated in Table 1 with respect to ID set 3.

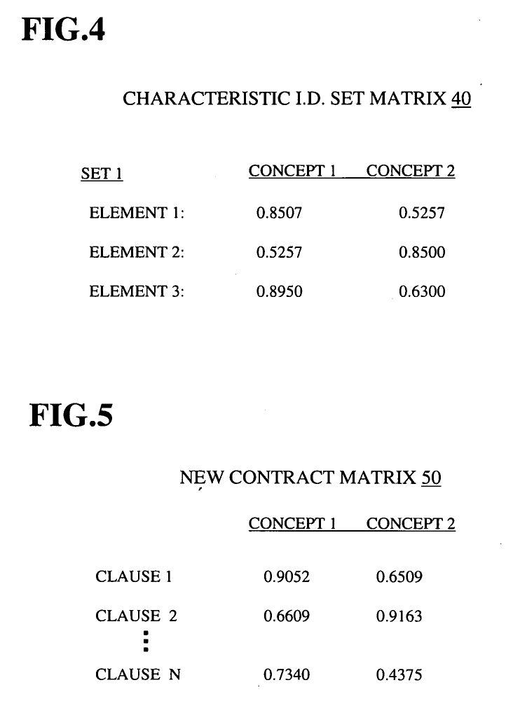

FIG. 4 is a diagram illustrating a matrix 40 that represents a two dimensional concept space that results from one or more of the characteristic ID sets being operated on by the NLP module 22 of FIG. 2. The matrix 40 includes three rows each of which represents one characteristic ID Element, “ID element 1”, “ID Element 2” and “ID Element 3” in the “Set 1” of characteristic ID elements in Table 1 and each of two columns represent secondary concepts, “Concept 1” and “Concept 2” that are identified as the result of the NLP module 22 operating on each of the ID Elements. The intersection of each row and column includes a value which is the value resulting from the NLP module 22 evaluating each ID element. Each value represents the correlation between one ID Element and a secondary concept identified by the NLP 22 of FIG. 2, with the higher the value indicating a stronger correlation. In this case, matrix 40 includes a value of 0.8507 which is the correlated value between “ID Element 1” and “Concept 1” and a value of 0.5257 which is the correlated value between “ID Element 1” and “Concept 2”. Matrix 40 includes a value of 0.5257 which is the correlated value between “ID Element 2” and “Concept 1” and a vector value of 0.8500 which is the correlated value between “ID Element 2” and “Concept 2”, and so forth with “ID Element 3”. As indicated earlier with reference to FIG. 2, each of these values is stored either permanently or temporarily in Matrix 40 in the ID Set value store 22B of the contract characteristic ID application 13.

FIG. 5 is a diagram illustrating a matrix 50 that represents a concept space resulting from the text of one or more contracts being operated on by the NLP module 22 of FIG. 2. The matrix 40 includes a plurality of rows 1-N each one of which represents one clause in a contract. For purposes of illustration, only three rows are included in FIG. 5, a first row labeled “clause 1”, a second row labeled “clause 2” and a third row labeled “clause N”. Matrix 40 also is illustrated to be comprised of two columns, each of which represent secondary concepts, “Concept 1” and “Concept 2” that are identified as the result of the NLP module 22 operating on each of the three types of clauses. Although matrix 40 is shown being comprised of two concepts, the characteristic identification system 10 is not limited to only indentifying two concepts for each clause in a contract. The intersection of each row and column, which is referred to as a matrix element, includes a value which is the value resulting from the NLP module 22 evaluating the text of each clause in a contract. Each value represents the correlation between a clause or contact text and a secondary concept identified by the NLP 22 of FIG. 2, with higher values indicating a stronger correlation. In this case, matrix 50 includes a vector value of 0.9052 which is the correlated value between “clause 1” and “Concept 1” and a vector value of 0.6509 which is the correlated value between “clause 1” and “Concept 2”. Matrix 50 includes a vector value of 0.6600 which is the correlated value between “clause 2” and “Concept 1” and a vector value of 0.9263 which is the correlated value between “clause 2” and “Concept 2”, and so forth with “clause 3”. As indicated earlier with reference to FIG. 2, each of these values is stored in Matrix 50 in clause value store 22C of the contract characteristic ID application 13.

FIG. 6 is an illustration showing the appearance of the user interface (UI) 20 in FIG. 2. UI 20 includes a field 61 that into which can be entered control number(s) of one or more legal contracts that have been scanned into the contract characteristic ID application 13. The UI 20 also includes a field 62 into which either an ID set descriptor or ID element descriptor, mentioned with reference to Table 1, can be entered. After the necessary information is entered into field 61 and 62, an evaluate contract field 65 is selected to invoke the characteristic ID application 13 evaluate the selected contract(s) against the submitted characteristic ID element. As a result, the number of contract text that are identified is listed in the “Results” 64 field and the text of the identified contract text are displayed in a field 65 in hierarchical order from strongest correlation to weakest correlation to the characteristic ID element entered in field 62.

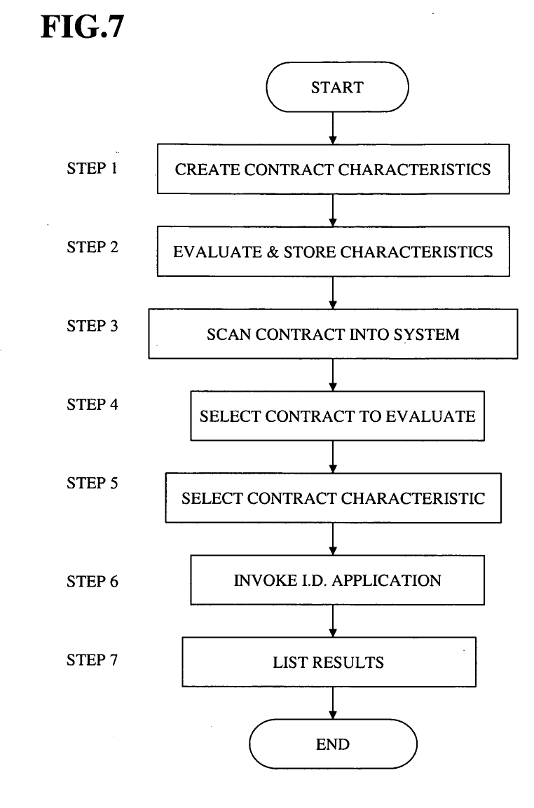

FIG. 7 is a logical flow diagram of the process of one embodiment of our invention. It is assumed, for the purpose of this descriptions that the contract characteristic identification system 10 has already been manually trained as described previously with reference to FIG. 2 and FIG. 3. In step 1, one or more contract characteristic identification sets are created, each of which includes one or more queries, rules or text contract text of interest. Alternatively, each characteristic identification set can include a mixture of queries, rules or text. In step 2 the contract characteristic ID application 13 employs the document evaluation function 22A to evaluate the information (queries, rules, text) that comprises each of the ID sets created in step 1 and this evaluation results in a value (as described with relation to FIGS. 3 and 5) being assigned to each of the ID elements. These values are stored for later or immediate use by the ID application 13. In step 3, the text of one or more contracts is entered into the contract characteristic ID application 12 and the application employs the document evaluation function 22A to identify concepts in the contract. Each concept is assigned a value as described with relation to FIGS. 3 and 5. In step 4, one or more stored contracts are selected for evaluation and in step 5 a characteristic ID set of interest or a particular ID element of interest is selected. Selecting the “evaluate contract” field/button located in the UI 20 invokes the contract characteristic ID application 13 which, in step 6, proceeds to evaluate the contents of the selected one or more contracts against the selected ID set or ID element of interest and, in step 7, returns a listing of contract text that are closest (distance between the vector values assigned to contract concepts and ID element vector values) to the selected ID set or ID elements. In another embodiment of our invention, the text of a contract is entered into the ID application 13 in step 1 of the process and the contract characteristics are created in a later step, such as in step 2. The order of the steps of entering the text of a contract and creating contract characteristics is not important and does not affect the automatic and accurate operation of the ID application 13, as the operation of the application 13 only depends upon its access to a store of contract characteristics values and a store of clause values.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method for identifying one or more document characteristics, comprising:
entering and storing the text of a document in a computer memory;
defining one or more document characteristics and storing them in the computer memory;
a trained natural language processing module operating on the one or more document characteristics to generate at least one value for each of the one or more document characteristics and operating on the text of the document to generate a plurality of document concept values; and
a document characteristic identification function employing the stored document characteristic values and the stored document concept values to identifying all document text that is within a preselected distance of the one or more defined document characteristics.

2. The method of claim 1 wherein each of the one or more document characteristics is associated with a defined degree of risk.

3. The method of claim 1 wherein the text of the document is one of a document clause, a document passage and document language of interest.

4. The method of claim 3 wherein the one of a document clause, a document passage and document language of interest is comprised of two or more words of textual information.

5. The method of claim 1 wherein each of the one or more document characteristics is associated with a different defined degree of risk.

6. The method claim 1 wherein the trained natural language processing module is comprised of a primary concept identification function and a secondary concept identification function.

7. The method of claim 1 wherein the document characteristic values represent a correlation between a characteristic identification element and a secondary document concept identified by the natural language processing module.

8. The method of claim 1 wherein the document concept value represents the correlation between document text and a secondary document concept identified by the natural language processing module.

9. A method for identifying a document characteristic, comprising:
entering the text of one or more documents into a document characteristic identification application;
defining one or more document characteristics and entering the one or more defined document characteristics into the document characteristic identification application;
the document characteristic identification application operating on the one or more entered document characteristics to generate a plurality of document characteristic values and operating on the entered text of the one or more documents to generate a plurality of document concept values; and
the document characteristic identification application employing the document characteristic values and the document concept values to identify all document text that is within a preselected distance of the one or more defined document characteristics.

10. The method of claim 9 wherein each of the one or more document characteristics is associated with a defined degree of risk.

11. The method of claim 9 wherein the text of the document is one of a document clause, a document passage and document language of interest.

12. The method of claim 11 wherein the one of a document clause, a document passage and document language of interest is comprised of two or more words of textual information.

13. The method of claim 9 wherein each of the one or more document characteristics is associated with a different defined degree of risk.

14. The method claim 9 wherein the document characteristic identification application is comprised of one or more document characteristic definitions, a natural language processing module and a characteristic identification function.

15. The method of claim 9 wherein the document characteristic values represent a correlation between a characteristic identification element and a secondary document concept identified by the document characteristic identification application.

16. The method of claim 9 wherein the document concept value represents the correlation between document text and a secondary document concept identified by the document characteristic identification application.

17. A computational device, comprising:
a user interface device;
a text entry device; and
a memory, the memory including;
a document characteristic identification application for operating on one or more of an entered document characteristics to generate a plurality of document characteristic values and operating on an entered text of a one or more documents to generate a plurality of document concept values; and
the document characteristic identification application employing the document characteristic values and the document concept values to identify all document text that is within a preselected distance of the one or more defined document characteristics

18. The computational device of claim 16 wherein each of the one or more document characteristics is associated with a defined degree of risk.

19. The computational device of claim 16 wherein the text of the document is one of a document clause, a document passage and document language of interest.

20. The computational device of claim 19 wherein the one of a document clause, a document passage and document language of interest is comprised of two or more words of textual information.

21. The computational device of claim 16 wherein each of the one or more document characteristics is associated with a different defined degree of risk.

22. The computational device of claim 16 wherein the document characteristic identification application is comprised of one or more document characteristic definitions, a natural language processing module and a characteristic identification function.

23. The computational device of claim 16 wherein the document characteristic values represent a correlation between a characteristic identification element and a secondary document concept identified by the document characteristic identification application.

24. The computational device of claim 16 wherein the document concept value represents the correlation between document text and a secondary document concept identified by the document characteristic identification application.
